(19) United States
(12) Patent Application Publication
(10) Pub. No.: US 2012/0057904 A1
(43) Pub. Date: Mar. 8, 2012

(54) DEVELOPING DEVICE AND IMAGE FORMING APPARATUS

(76) Inventors: Hiroyoshi MAEHARA, Osaka-shi (JP); Takahiko Kimura, Osaka-shi (JP); Hiroshi Kubota, Osaka-shi (JP); Teruyoshi Sudo, Osaka-shi (JP)

(21) Appl. No.: 13/222,226

(22) Filed: Aug. 31, 2011

(30) Foreign Application Priority Data
Sep. 3, 2010 (JP) 2010-197955

(51) Int. Cl. G03G 15/08

(52) U.S. Cl. 399/254

(57) ABSTRACT

A developing device includes a developing tank, a developing roller, a supply toner carrying path, and a supply toner diffusion screw. A partition board provided parallel to the developing roller in the developing tank has, in an axial direction of the supply toner diffusion screw, a first region and a second region lower than the first region. The first region is located so as to face a region perpendicularly below a toner supply opening, and the second region is located so as not to face the region perpendicularly below the toner supply opening.

This Nonprovisional application claims priority under 35 U.S.C. §119(a) on Patent Application No. 2010-197955 filed in Japan on Sep. 3, 2010, the entire contents of which are hereby incorporated by reference.

### TECHNICAL FIELD

The present invention relates to (i) a developing device that employs a two-component developer containing toner and a magnetic carrier and (ii) an image forming apparatus employing the developing device. The present invention is for use in an image forming apparatus, such as an electrostatic copying machine, a laser printer or a facsimile, that forms an image by use of toner by means of an electrophotographic printing method.

### BACKGROUND ART

Conventionally, electrophotographic image forming apparatuses, such as a copying machine, a printer and a facsimile, have been known. In such electrophotographic image forming apparatuses, an electrostatic latent image is formed on a surface of a photoreceptor drum, the electrostatic latent image is developed by supplying toner from a developing device to the photoreceptor drum. Thereafter, a toner image formed on the photoreceptor drum by the developing is transferred from the photoreceptor drum to a sheet such as paper, and then the toner image, transferred to the sheet, is fixed to the sheet by a fixing device.

In an image forming apparatus which complies with full color and high definition, a two-component developer (hereinafter simply referred to as a developer), which is excellent in charging stability of toner, has been commonly employed recently.

The developer consists of toner and a carrier, and they are stirred in a developing device. The stirring causes friction between the toner and the carrier. The friction causes the toner to be properly charged.

The toner charged is supplied to a surface of a developer bearing member, for example, a surface of a developing roller in the developing device. The toner supplied to the developing roller is moved by electrostatic attraction toward the electrostatic latent image formed on the photoreceptor drum. In this manner, the toner image is formed on the photoreceptor drum in accordance with the electrostatic latent image.

Further, speeding up and downsizing have been recently required for the image forming apparatus. In order to meet such requirements, it is necessary to (i) keep a toner concentration of the developer at a proper concentration, (ii) immediately and sufficiently charge the developer, and (iii) immediately carry the developer.

As to the speeding up of the image forming apparatus, for example, Patent Literature 1 discloses a developing device for supplying toner from a toner supply device to a region of a developing tank which region corresponds to an image forming region of a developing roller. According to the developing device, since the speeding up of the image forming apparatus is attained, the toner supplied is immediately dispersed in the developer so as to obtain appropriate toner concentration and charging quantity.

Specifically, the developing device has a configuration for directing toner from the toner supply device into the developing tank. According to such a configuration, a width, in an axial direction of the developing roller, of a toner reception opening formed in the developing tank substantially equals to that of the image forming region. This configuration makes it possible to supply the toner, supplied to the developing tank, evenly all over the image forming region of the developing roller.

### CITATION LIST

### Patent Literature

Patent Literature 1

Japanese Patent Application Publication, Tokukai No. 2008-224777 A (Publication Date: Sep. 25, 2008)

### SUMMARY OF INVENTION

### Technical Problem

However, according to the developing device disclosed in Patent Literature 1, the toner supply device is downsized in the axial direction of the developing roller. This causes a reduction in width of the toner reception opening, that is, a reduction in width of a toner supply opening. In this case, the toner supplied to the developing tank is taken in merely a developer present in the vicinity of the toner reception opening. This causes unevenness of the toner concentration of the developer, in the axial direction of the developing roller. Supplying of such toner to the developing roller causes a problem that an image concentration becomes unstable and uneven in the axial direction of the developing roller.

In view of the problem, an object of the present invention is to provide (i) a developing device that can evenly disperse, in an axial direction of a developing roller, toner supplied from a toner supply device, even in a case where a length of a toner supply opening of the toner supply device is reduced in the axial direction of the developing roller due to downsizing of, for example, the toner supply device and an image forming apparatus employing the developing device.

### Solution to Problem

In order to attain the object, a developing device of the present invention, including: a developing tank, which contains developer containing toner and magnetic carrier and which has a toner supply opening through which toner is supplied into the developing tank; a developing roller, provided in the developing tank, that bears the developer to supply the developer to a photoreceptor; a supply toner carrying path, provided in the developing tank, that (i) is separated from a region on a developing roller side by a partition board provided parallel to the developing roller, is provided longer than an opening length of the toner supply opening in a longitudinal direction of the toner supply opening, and (iii) receives the toner supplied through the toner supply opening; and a supply toner diffusion screw, provided in the supply toner carrying path, that (i) rotates to stir and diffuse supplied toner in the supply toner carrying path and (ii) moves, beyond the partition board, the supplied toner in the supply toner carrying path so as to supply the supplied toner to the region on the developing roller side, the partition board having, in an axial direction of the supply toner diffusion screw, a first region and a second region lower than the first region, the first region being located so as to face a region perpendicularly below the toner supply opening in the supply toner carrying path, and the second region being located so as not to face the region perpendicularly below the toner supply opening in the supply toner carrying path.

According to the above configuration, the toner that drops in the supply toner carrying path is tried, by rotation of the supply toner diffusion screw, to move beyond the partition board to reach the region on the developing roller side. However, the moving of the toner toward the region on the developing roller side is suppressed by the first region that is relatively higher than the second regions. That is, such a configuration that includes the partition board makes it difficult to supply the toner, by rotation of the supply toner diffusion screw, from the supply toner carrying path toward the region on the developing roller side, via a region corresponding to the first region of the partition board. In contrast, such a configuration makes it easy to supply the toner, by rotation of the supply toner diffusion screw, from the supply toner carrying path toward the region on the developing roller side, via regions corresponding to the respective second regions of the partition board.

It becomes thus easy to diffuse the toner in the axial direction of the supply toner diffusion screw while stirring the toner and the developer in the supply toner carrying path. It is therefore possible to prevent unevenness of quantity of the toner to be supplied from the supply toner carrying path toward the region on the developing roller side by rotation of the supply toner diffusion screw. Note that the unevenness of quantity of the toner has conventionally occurred depending on a position of the supplied toner in the axial direction of the supply toner diffusion screw. It is consequently possible to prevent unevenness of an image concentration, which occurs in the axial direction of the developing roller, caused by the unevenness of the quantity of the toner to be supplied.

### Advantageous Effects of Invention

As described above, according to the configuration of the present invention, it becomes easy to diffuse the toner in the axial direction of the supply toner diffusion screw while stirring the toner and the developer in the supply toner carrying path. It is therefore possible to prevent unevenness of quantity of the toner to be supplied from the supply toner carrying path toward the region on the developing roller side by rotation of the supply toner diffusion screw. Note that the unevenness of quantity of the toner has conventionally occurred depending on a position of the supplied toner in the axial direction of the supply toner diffusion screw. It is consequently possible to prevent unevenness of an image concentration, which occurs in the axial direction of the developing roller, caused by the unevenness of the quantity of the toner to be supplied.

### BRIEF DESCRIPTION OF DRAWINGS

FIG. 1 is a longitudinal cross-sectional view of an image forming apparatus in accordance with an embodiment of the present invention.

FIG. 2 is a longitudinal cross-sectional view schematically showing a developing device shown in FIG. 1.

FIG. 3 is a cross-sectional view taken along A-A line of FIG. 2.

FIG. 4 is a longitudinal cross-sectional view schematically showing a toner supply device shown in FIG. 1.

FIG. 5 is a cross-sectional view taken along B-B line of FIG. 4.

### DESCRIPTION OF EMBODIMENTS

The following describes an embodiment of the present invention with reference to drawings.

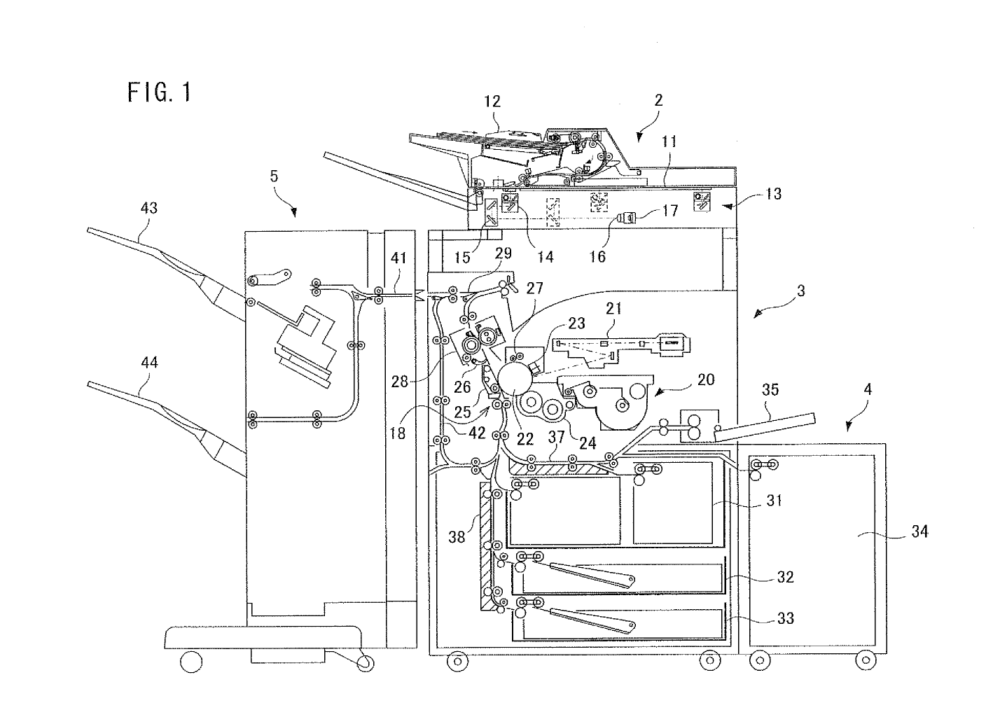

FIG. 1 is a longitudinal cross-sectional view of an image forming apparatus in accordance with an embodiment of the present invention.

An image forming apparatus includes an image reading section 2, an image forming section 3, and a paper feeding section 4, and a paper output section 5, as shown in FIG. 1.

The image reading section 2 includes a scanner platen made of a transparent glass, a reverse automatic document feeder (RADF) 12 for automatically supplying a document onto the scanner platen 11 such that both sides of the document are read, and a document image reading unit, that is, a scanner unit 13 for scanning and reading an image of the document placed on the scanner platen 11.

The reverse automatic document feeder 12 automatically feeds, one by one, a plurality of documents placed on a document tray onto the scanner platen 11 of the scanner unit 13. The reverse automatic document feeder 12 includes a carrying path for a single-sided document, a carrying path for a double-sided document, and means for switching the carrying paths. This enables the scanner unit 13 to read one side or both sides of the document in accordance with a user's selection.

The scanner unit 13 includes a lamp reflector assembly for exposing a surface of the document, a Charge Coupled Device (CCD) 17, a first scanning unit 14 equipped with a first reflection mirror, a second scanning unit 15 equipped with second and third reflection mirrors, and an optical lens 16.

The Charge Coupled Device (CCD) 17 converts an image of light reflected from a document into an electric signal, that is, an image signal. The first scanning unit 14 and the second scanning unit 15 guide the image of light reflected from the document toward the Charge Coupled Device (CCD) 17 by use of the first through third reflection mirrors. The first scanning unit 14 is controlled to move at a constant rate V from left to right along the scanner platen 11, and the second scanning unit 15 is also controlled to move at a constant rate V/2 from left to right along the scanner platen 11. The optical lens 16 forms the image of light reflected from the document onto the Charge Coupled Device (CCD) 17.

In the image reading section 2, the reverse automatic document feeder 12 operates in association with the scanner unit 13. That is, the reverse automatic document feeder 12 sequentially feeds, one by one, documents to be read onto the scanner platen 11, and the scanner unit 13 reads images of the documents by causing the CCD 17 to form the images of the documents for each line.

Image data, obtained by causing the scanner unit 13 to scan the images of the documents, is subjected to various processes, and is then temporarily stored in a memory. Subsequently, the image data is supplied from the memory to the image forming section 3 in response to an output instruction, and is then made into a visual image, that is, a toner image on a photoreceptor drum 22. Thereafter, the toner image formed on the photoreceptor drum 22 is transferred onto paper, and is then fixed onto the paper.

The image forming section 3 includes a laser scanning unit (LSU) 21 and an electrophotography processing section 18 which carry out the processes.

The laser scanning unit 21 includes a semiconductor laser, a polygon mirror, an f-θ lens and other components. The semiconductor laser emits laser beam in accordance with the image data read from the memory or image data supplied from an external device such as a personal computer. The polygon mirror deflects the laser beam at a constant angular velocity. The f-θ lens corrects the laser beam, deflected at the constant angular velocity, so as to scan a surface of the photoreceptor drum 22 at a constant velocity.

In the electrophotography processing section 18, a charging device 23, a developing device 24, a transfer device 25, a separation device 26, a cleaning device 27, and a charge removal device are provided around the photoreceptor drum 22. Further, a fixing device 28 is provided downstream of the photoreceptor drum 22.

The paper feeding section 4 includes first through third cassettes 31 through 33, and a manual paper feeding tray 35. Note that the paper feeding section 4 can include a large volume cassette 34 as appropriate. The first cassette 31 is a tandem tray for containing first and second trays. The first and second trays can be simultaneously drawn out from a main body of the image forming apparatus. The second cassette 32 and the third cassette 33 contain third and fourth trays, respectively. That is, the three cassettes 31 through 33 contain the four trays in total. Paper carrying sections 37 and 38 carry paper stored in the paper-feeding section 4 to a transfer position between the photoreceptor drum 22 and the transfer device 25. This necessitates provision of paper feeding rollers, carrying rollers, and resist rollers.

Each of the four trays of the first through third cassettes 31 through 33 of the paper feeding section 4 contains stacked papers of a corresponding size. The paper feeding section 4 feeds paper one by one from the top of the stacked paper in a tray selected by a user. The paper is sequentially fed, one by one, to the electrophotography processing section 18, via the paper carrying section 37 or 38.

A paper output path 29 is provided downstream of the fixing device 28 in a direction in which the paper is fed. The paper output path 29 branches into (i) a paper output path 41 of the paper output section 5 and (ii) a carrying section 42 for double-sided copy.

In the image forming section 3, the image data read from the memory is formed, as an electrostatic latent image, on the surface of the photoreceptor drum 22 by causing the laser scanning unit 21 to scan the image data with laser beam. The electrostatic latent image is developed, as a toner image, by use of toner in the developing device 24. The toner image is transferred, by the transfer device 25, onto the paper fed by the paper feeding section 4, and is then fixed onto the paper by the fixing device 28. Note that a toner supply device 20 supplies toner to the developing device 24 as appropriate.

The paper on which the image is formed is selectively carried from the fixing device 28 to the paper output section 5 or to the carrying section 42 for double-sided copy. The paper, which is carried to the paper output section 5, is subjected to a predetermined process such as sorting and/or stapling if necessary, and is then stacked on the first discharge tray 43 or the second discharge tray 44. Meanwhile, the paper, which is carried to the carrying section 42 for double-sided copy, is reversed in the carrying section 42, and is then carried back to the electrophotography processing section 18. In the electrophotography processing section 18, an image is formed on a surface of the paper on which surface an image has not been formed yet. Thereafter, the paper is discharged via the fixing device 28.

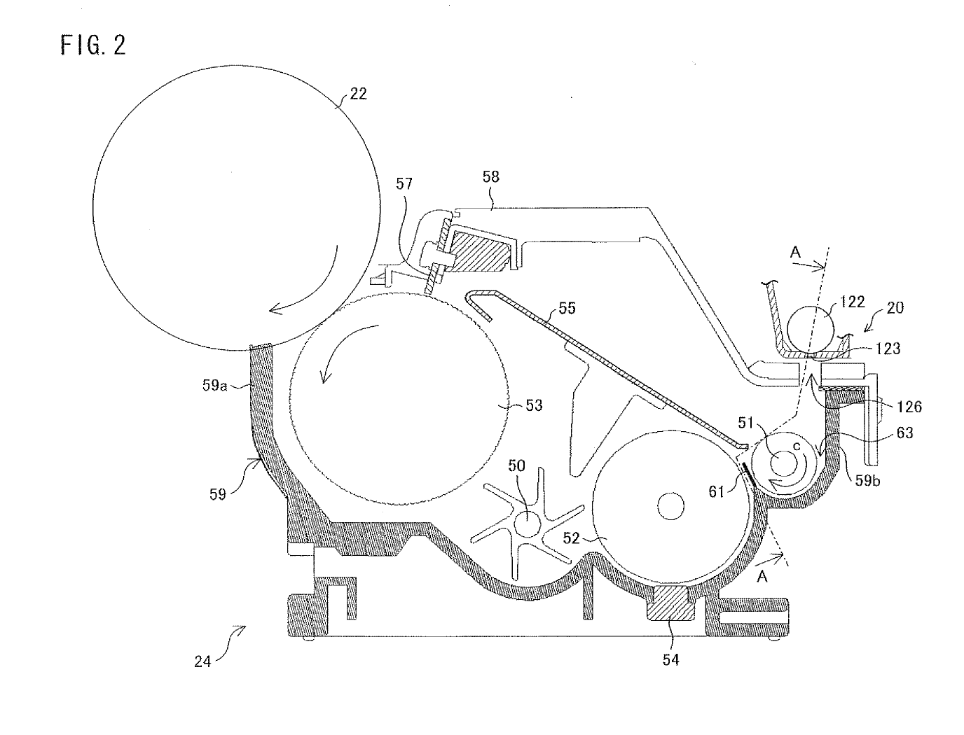

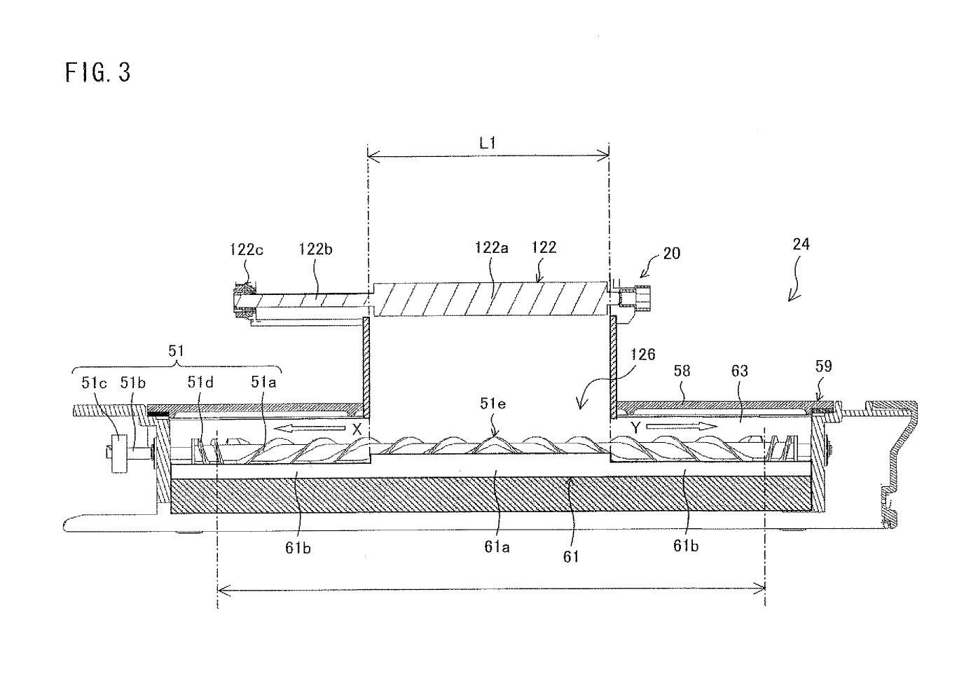

FIG. 2 is a longitudinal cross-sectional view schematically showing the developing device 24 shown in FIG. 1. FIG. 3 is a cross-sectional view taken along A-A line of FIG. 2.

As shown in FIG. 2, the developing device 24 includes a developing tank 59, a developing roller 53, a first developer stirring member 50, a second developer stirring member 52, a supply toner diffusion screw 51, a layer thickness control member 57, a drainboard 55, and a toner concentration sensor 54.

The developing tank 59 is a hollow container made from a hard synthetic resin, and has an upper wall which serves as a detachable developing tank cover 58. The developing tank 59 contains a developer containing toner and a magnetic carrier. The developing tank 59 has an opening 60 where the photoreceptor drum 22 faces the developing roller 53 provided in the developing tank 59.

Specifically, the developing roller 53 is provided in the developing tank 59 so as to be closest to the photoreceptor drum 22. The first developer stirring member 50, the second developer stirring member 52, and the supply toner diffusion screw 51 are provided, in this order, in the developing tank 59 so as to (1) be farther from the photoreceptor drum 22 than the developing roller 53, and (ii) have their respective axial directions which are parallel to one another. The toner concentration sensor 54 is provided below the second developer stirring member 52 in a bottom wall of the developing tank 59.

The developing roller 53 is a magnetic roller which bears, on a surface of the developing roller 53, developer stored in the developing tank 59, and then supplies the developer to the photoreceptor drum 22. Further, the developing roller 53 is provided parallel to the photoreceptor drum 22 in the axial direction so as to has a peripheral surface facing the photoreceptor drum 22.

The first developer stirring member 50 stirs the developer in the developing tank 59 by rotating on its axis, so as to supply stirred developer to the developing roller 53. The second developer stirring member 52 stirs the developer in the developing tank 59 by rotating on its axis, so as to supply stirred developer to the first developer stirring member 50.

The layer thickness control member 57 is, for example, a thin oblong stainless steel plate that extends parallel to the axial direction of the developing roller 53.

The layer thickness control member 57 is provided so that its fixed end is attached to an inner wall of the developing tank 59 and its free end is provided so as to be away, by a predetermined distance, from the peripheral surface of the developing roller 53. This allows the layer thickness control member 57 to control a layer thickness of the developer formed on the surface of the developing roller 53.

The drainboard 55 is, for example, a substantially oblong metal plate, and guides, to the supply toner diffusion screw 51, excess developer which is controlled by the layer thickness control member 57 and left on the developing roller 53. On this account, the drainboard 55 extends, to the supply toner diffusion screw 51, from a position that is above the developing roller 53 and that is upstream of the thickness layer control member 57 in a direction in which the developing roller 53 rotates. Further, the drainboard 55 inclines downward from the developing roller 53 to the supply toner diffusion screw 51.

The toner concentration sensor 54 is a magnetic permeability sensor that detects a toner concentration of the developer stored in the developing tank 59.

The supply toner diffusion screw 51 supplies developer, which contains toner supplied from the toner supply device 20, to the second developer stirring member 52, that is, to a region where the developing roller 53 is provided. The supply toner diffusion screw 51 is provided along a back wall part 59b of the developing tank 59. Note that the developing tank 59 has a front wall part 59a that is located on a near side of the photoreceptor drum 22 and the back wall part 59b that is located on a side opposite to the near side. The region where the supply toner diffusion screw 51 is provided forms part of the supply toner carrying path 63.

An upper surface of a bottom wall of the developing tank 59 in the supply toner carrying path 63 is located higher than an upper surface of a bottom wall of the developing tank 59 in a region where the second developer stirring member 52 is provided. Specifically, in the present embodiment, the upper surface of the bottom wall of the developing tank 59 in the supply toner carrying path 63 is located around a shaft center of the second developer stirring member 52. That is, a shaft center of the supply toner diffusion screw 51 is located higher than the shaft center of the second developer stirring member (developer stirring member) 52.

As shown in FIG. 3, according to the supply toner diffusion screw 51, a spiral blade 51a is provided around a rotation shaft 51b. The spiral blade 51a is, for example, configured such that the spiral blade 51a extends (i) in a first spiral direction from a boundary point 51e (substantially a center point of a region, in an axial direction of the rotation shaft 51b, where the spiral blade 51a is provided) toward one end part of the region and (ii) in a second spiral direction which is reverse to the first spiral direction from the boundary point 51e toward the other end part of the region. This allows the supply toner diffusion screw 51 to carry, by rotating on its axis, the developer containing the toner from a center part of the supply toner carrying path 63 to both end parts of the supply toner carrying path 63.

Further, the supply toner diffusion screw 51 includes return blades 51d in the both end parts of the supply toner diffusion screw 51. The return blades 51d carry back the developer toward the center part of the supply toner diffusion screw 51. This can prevent the developer from staying in the both end parts of the supply toner diffusion screw 51, that is, from staying in the vicinity of both sidewalls of the developing tank 59 in the axial direction of the supply toner diffusion screw 51. Note that a gear 51c, which transmits driving force to the supply toner diffusion screw 51, is provided at an edge of the rotation shaft 51b of the supply toner diffusion screw 51.

Further, a toner supply opening 126 through which the toner is supplied from the toner supply device 20 is formed above the supply toner carrying path 63. The toner which is supplied into the developing tank 59 through the toner supply opening 126 drops on the supply toner diffusion screw 51 which is provided in the supply toner carrying path 63.

Further, the toner supply opening 126 is formed so as to extend from the center part (the boundary point 51e) in the axial direction of the supply toner diffusion screw 51 toward the both edges of the supply toner diffusion screw 51 in the axial direction of the supply toner diffusion screw 51. Specifically, a length of the supply toner opening 126 in the axial direction of the supply toner diffusion screw 51, that is, a length L1 of the opening of the toner supply opening 126 equals to a length of a toner discharge opening 123 of the toner supply device 20.

The toner discharge opening 123 is an opening through which the toner (supply toner) discharged from the toner supply device 20 is supplied into the developing tank 59. Specifically, the toner is discharged through the toner discharge opening 123 by rotation of a toner discharge member 122 which is provided in the toner discharge opening 123 of the toner supply device 20. The length of the opening of the toner discharge opening 123 substantially equals to a length L2 of a roller part 122a of the toner discharge member 122 in an axial direction of the roller part 122a. That is, the length L1 of the opening of the toner supply opening 126 equals to the length L2 in the axial direction of the toner discharge member 122.

A partition board 61 is provided on a side opposite to a side on which the back wall part 59b of the supply toner carrying path 63 is provided. The partition board 61 serves as a wall (sidewall) opposite to the back wall part 59b in the supply toner carrying path 63. The partition board 61 extends, parallel to the axial direction of the supply toner diffusion screw 51 (the axial direction of the developing roller 53), from one end part of the supply toner carrying path 63 to the other end part of the supply toner carrying path 63.

Further, the partition board 61 has different heights in the axial direction of the supply toner diffusion screw 51. Specifically, the partition board 61 has (i) a first region 61a that is a relatively high region and (ii) second regions 61b that are relatively low regions. This configuration of the partition board 61 makes it possible to adjust quantity of the toner (developer containing the toner) to be supplied to the second developer stirring member 52 in the axial direction of the supply toner diffusion screw 51 by rotation of the supply toner diffusion screw 51.

According to an example of the partition board 61 shown in FIG. 3, the first region 61a corresponds to a center part of the partition board 61 in the axial direction of the supply toner diffusion screw 51, and the second regions 61b correspond to side parts of the partition board 61. Specifically, the partition board 61 is configured so that (i) the first region 61a that is highest is located perpendicularly below the toner supply opening 126 and (ii) the second regions 61b that are lower than the first region 61a are located in both sides of the first region 61a.

It is preferable that a length of the first region 61a of the partition board 61 in the axial direction of the supply toner diffusion screw 51 equal to the length of the toner supply opening 126 in the axial direction of the supply toner diffusion screw 51 (see FIG. 3). Note, however, that a slight difference between the length of the first region 61a of the partition board 61 and the length of the toner supply opening 126 causes no problem. Specifically, the difference of the length of the first region 61a of the partition board 61 with respect to the length of the toner supply opening 126 can be in a range of ±10%. Note that it is preferable that the difference be not a minus value but a plus value in view of the partition board 61.

Further, in the present embodiment, the height of the first region 61a equals to that of the shaft center of the rotation shaft 51b of the supply toner diffusion screw 51. Meanwhile, the height of the second regions 61b (i) is lower than that of the shaft center of the rotation shaft 51b of the supply toner diffusion screw 51 and (ii) equals to a lowest point that the spiral blade 51a reaches or is higher than the lowest point.

Note that, in the present embodiment, the first region 61a is configured so that its both end parts rise perpendicularly at a boundary between the first region 61a and the respective second regions 61b. However, the present embodiment is not limited to this. The both end parts of the first region 61a can therefore be configured so as to rise obliquely at a boundary between the first region 61a and the respective second regions 61b from the top surfaces of the respective second regions 61b (see FIG. 3). In this case, an angle at which the first region 61a rises obliquely is determined by taking into consideration how much the supply toner diffusion screw 51 can carry the toner (developer containing the toner).

Note also that the present embodiment has discussed the case where the partition board 61 includes two regions different in height from each other but is not limited to this. For example, the partition board 61 can include not less than three regions different in height from one another. In this case, the highest one of the three or more regions should be located perpendicularly below the toner supply opening 126.

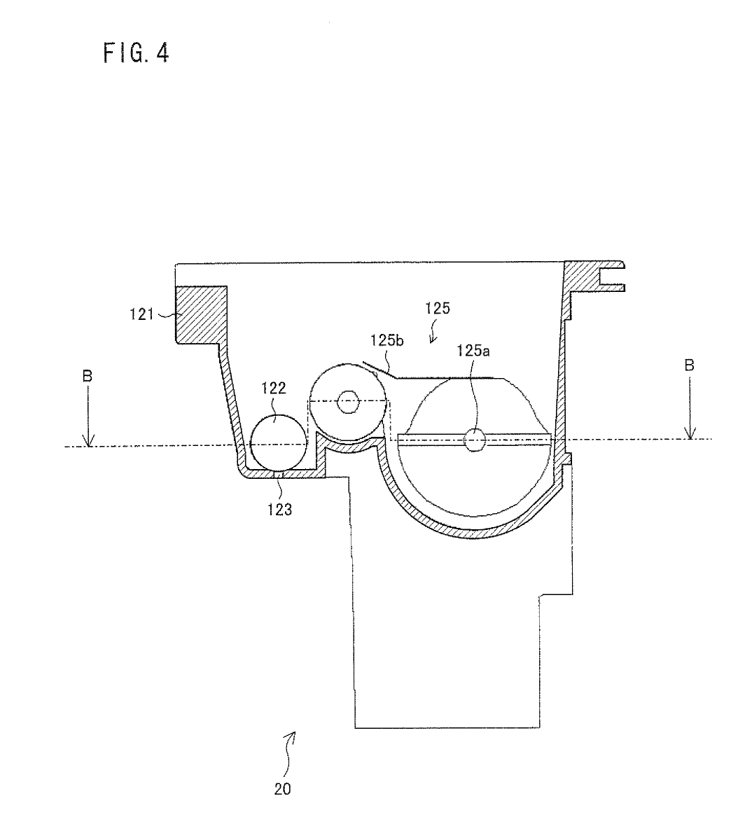

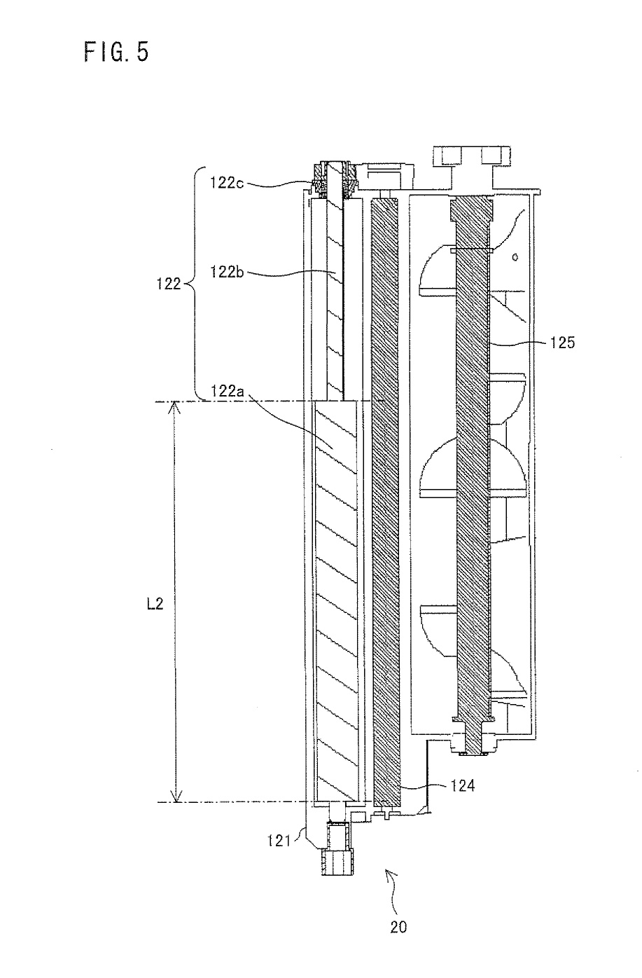

FIG. 4 is a longitudinal cross-sectional view schematically showing the toner supply device 20 shown in FIG. 1. FIG. 5 is a cross-sectional view taken along B-B line of FIG. 4.

As shown in FIG. 4, the toner supply device 20 includes a toner container 121. The toner container includes a toner stirring member 125, a toner carrying member 124, and a toner discharge member 122. A toner discharge opening 123 is formed in a lower wall part of the toner container 121 below the toner discharge member 122. The toner discharge opening 123 is oblong. Further, the toner container 121 stores toner which has not been used. The toner is supplied to the developing tank 59 through the toner discharge opening 123 by rotation of the toner discharge member 122.

The toner stirring member 125 is a plate member, and includes a toner scoop-up member 125b at its leading end part. The toner scoop-up member 125b is made from a polyethylene terephthalate (PET) sheet having flexibility. The toner stirring member 125 scoops up, while stirring, the toner stored in the toner container 121 by rotating around a rotation shaft 125a, and carries the toner to the toner carrying member 124.

The toner carrying member 124 is a screw member for adjusting toner quantity which is carried in an axial direction of the toner carrying member 124, and carries the toner supplied from the toner carrying member 125 toward the toner discharge member 122.

The toner discharge member 122 supplies the toner stored in the toner container 121 to the developing tank 59 through the toner discharge opening 123 by rotating. Further, as shown in FIG. 5, the toner discharge member 122 includes a roller part 122a made of, for example, a sponge, a rotation shaft 122b and a gear 122c. The rotation shaft 122b penetrates the roller part 122a. The gear 122c, which is provided at an end part of the rotation shaft 122b, transmits driving force to the rotation shaft 122b. In the present embodiment, the length L2 of the roller part 122a of the toner discharge member 122 equals to the length L1 of the opening of the toner supply opening 126.

With the configuration, the toner stored in the toner supply device 20 is discharged from the toner discharge opening 123 by rotation of the toner discharge member 122. Discharged toner is taken in the developing tank 59 through the toner supply opening 126, and then drops on the supply toner diffusion screw 51 in the supply toner carrying path 63. In this case, the toner drops on the supply toner diffusion screw 51 over a range of the length L1 of the opening of the toner supply opening 126.

The toner dropped on the supply toner diffusion screw 51 from the toner supply device 20 is carried, in the supply toner carrying path 63, from the boundary point 51e in two directions opposite to each other, that is, in X and Y directions shown in FIG. 3 while being stirred with the developer stored in the supply toner carrying path 63, by rotation of the supply toner diffusion screw 51. In this case, the developer stored in the supply toner carrying path 63 is a developer that has been (i) removed from the surface of the developing roller 53 by the layer thickness control member 57 and (ii) then supplied to the supply toner carrying path 63 by the drainboard 55.

Further, the supply toner diffusion screw 51 rotates in the supply toner carrying path 63 in a direction (in a direction indicated by arrow “c” shown in FIG. 2) in which a developer present in a bottom part of the supply toner carrying path 63 is scooped up and then carried upward from bottom along an inner surface of the partition board 61, that is, along a surface of the partition board 61 which surface faces the supply toner carrying path 63.

As described above, the first region 61a of the partition board 61 is located so as to face a region perpendicularly below the toner supply opening 126 in the supply toner carrying path 63, and has a height greater than that of the second regions 61b provided in the both sides of the first region 61a. Meanwhile, the second regions 61b of the partition board 61b are located so as not to face the region perpendicularly below the toner supply opening 126 in the supply toner carrying path 63.

Accordingly, the toner that drops in the supply toner carrying path 63 is tried, by rotation of the supply toner diffusion screw 51, to move beyond the partition board 61 to reach a side on which the second developer stirring member 52 is provided. However, the moving of the toner toward the second developer stirring member 52 is suppressed by the first region 61a that is relatively higher than the second regions 61b. That is, such a configuration that includes the partition board 61 makes it difficult to supply the toner (developer containing the toner), by rotation of the supply toner diffusion screw 51, from the supply toner carrying path 63 toward the second developer stirring member 52, via a region corresponding to the first region 61a of the partition board 61. In contrast, such a configuration makes it easy to supply the toner (developer containing the toner), by rotation of the supply toner diffusion screw 51, from the supply toner carrying path 63 toward the second developer stirring member 52, via regions corresponding to the respective second regions 61b of the partition board 61.

It becomes thus easy to carry the toner toward the both edges in the axial direction of the supply toner diffusion screw 51 from the boundary point 51e of the supply toner diffusion screw 51 while stirring the toner and the developer in the supply toner carrying path 63. It is therefore possible to prevent unevenness of quantity of the toner (developer containing the toner) to be supplied from the supply toner carrying path 63 toward the second developer stirring member 52 by rotation of the supply toner diffusion screw 51. Note that the unevenness of quantity of the toner has conventionally occurred depending on a position of the supplied toner in the axial direction of the supply toner diffusion screw 51.

It is consequently possible to prevent unevenness of an image concentration, which occurs in the axial direction of the developing roller 53, caused by the unevenness of the quantity of the toner to be supplied. Further, the toner and the developer can be sufficiently stirred. This makes it possible to prevent (i) the toner from being scattered and (ii) an image from being stained by scattered toner.

The present embodiment describes, as an example, a case where the developing device 24 is applied to the image forming apparatus shown in FIG. 1. However, an image forming apparatus to which the developing device 24 is applicable is not limited to the image forming apparatus of the present embodiment. Any image forming apparatuses are applicable, provided that (i) it employs a developing device in which a supply toner diffusion screw is provided below a toner supply opening in a developing tank and (ii) the supply toner diffusion screw carries, while stirring, developer.

The developing device can be configured such that the toner supply opening is formed so as to have its longitudinal direction parallel to the axial direction of the supply toner diffusion screw, and the supply toner diffusion screw has a first spiral blade and a second spiral blade whose spiral directions are opposite to each other, the first spiral blade being formed in the axial direction of the supply toner diffusion screw, to extend toward one side of the axial direction from a boundary point, the second spiral blade being formed in the axial direction of the supply toner diffusion screw, to extend toward the other side of the axial direction from the boundary point, and the boundary point being identical to a center point of the longitudinal direction of the toner supply opening when the boundary point is viewed from a perpendicular direction.

According to the above configuration, the supply toner diffusion screw has a first spiral blade and a second spiral blade whose spiral directions are opposite to each other, the first spiral blade being formed in the axial direction of the supply toner diffusion screw, to extend toward one side of the axial direction from a boundary point, the second spiral blade being formed in the axial direction of the supply toner diffusion screw, to extend toward the other side of the axial direction from the boundary point, and the boundary point being identical to a center point of the longitudinal direction of the toner supply opening when the boundary point is viewed from a perpendicular direction. It is therefore possible to efficiently diffuse the toner in the supply toner carrying path by rotation of the supply toner diffusion screw.

The developing device may be configured such that the supply toner diffusion screw rotates in a direction in which the developer present in a bottom part of the supply toner carrying path (i) is scooped up and (ii) is then carried upward from bottom along a surface of the partition board which surface faces the supply toner carrying path.

According to the above configuration, the supply toner diffusion screw rotates in a direction in which the developer present in a bottom part of the supply toner carrying path (i) is scooped up and (ii) is then carried upward from bottom along a surface of the partition board which surface faces the supply toner carrying path. Accordingly, the toner supplied to the supply toner carrying path will never move beyond the partition board, so as to be directly supplied to the region on the developing roller side. That is, by rotation of the supply toner diffusion screw, the toner supplied to the supply toner carrying path is at least scooped up via the bottom part of the supply toner carrying path, and is then carried upward from bottom along the surface of the partition board which surface faces the supply toner carrying path. It is therefore possible to sufficiently stir the toner and existing developer in the supply toner carrying path. This allows the toner to be sufficiently charged in the supply toner carrying path.

The developing device may further include a drainboard having one side located near a surface of the developing roller and another side, opposite to the one side, which is located in the supply toner carrying path, the drainboard inclining downward from the one side to the another side, the drainboard guiding the developer borne by the developing roller to the supply toner carrying path.

According to the above configuration, the developer born by the developing roller is guided to the supply toner carrying path by the drainboard, and then the developer and the toner are stirred in the supply toner carrying path by rotation of the supply toner diffusion screw. Such stirring allows the toner to be sufficiently charged.

The present invention is not limited to the description of the embodiments above, and can therefore be modified by a skilled person in the art within the scope of the claims.

Namely, an embodiment derived from a proper combination of technical means disclosed in different embodiments is encompassed in the technical scope of the present invention.

### REFERENCE SIGNS LIST

3: image forming section
20: toner supply device
22: photoreceptor drum
24: developing device
50: first developer stirring member
51: supply toner diffusion screw
51a: spiral blade
51b: rotation shaft
51d: return blade
51e: boundary point
52: second developer stirring member
53: developing roller
55: drainboard
58: developing tank cover
59: developing tank
59a: front wall part
59b: back wall part
61: partition board
61a: first region
61b: second region
122: toner discharge member
123: toner discharge opening
122a: roller part
122b: rotation shaft
126: toner supply opening

1. A developing device, comprising:
a developing tank, which contains developer containing toner and magnetic carrier and which has a toner supply opening through which toner is supplied into the developing tank;
a developing roller, provided in the developing tank, that bears the developer to supply the developer to a photoreceptor;
a supply toner carrying path, provided in the developing tank, that (i) is separated from a region on a developing roller side by a partition board provided parallel to the developing roller, (ii) is provided longer than an opening length of the toner supply opening in a longitudinal direction of the toner supply opening, and (iii) receives the toner supplied through the toner supply opening; and
a supply toner diffusion screw, provided in the supply toner carrying path, that (i) rotates to stir and diffuse supplied toner in the supply toner carrying path and (ii) moves, beyond the partition board, the supplied toner in the supply toner carrying path so as to supply the supplied toner to the region on the developing roller side,
the partition board having, in an axial direction of the supply toner diffusion screw, a first region and a second region lower than the first region, the first region being located so as to face a region perpendicularly below the toner supply opening in the supply toner carrying path, and the second region being located so as not to face the region perpendicularly below the toner supply opening in the supply toner carrying path.

2. The developing device as set forth in claim 1, wherein:
the toner supply opening is formed so as to have its longitudinal direction parallel to the axial direction of the supply toner diffusion screw, and
the supply toner diffusion screw has a first spiral blade and a second spiral blade whose spiral directions are opposite to each other, the first spiral blade being formed in the axial direction of the supply toner diffusion screw, to extend toward one side of the axial direction from a boundary point, the second spiral blade being formed in the axial direction of the supply toner diffusion screw, to extend toward the other side of the axial direction from the boundary point, and the boundary point being identical to a center point of the longitudinal direction of the toner supply opening when the boundary point is viewed from a perpendicular direction.

3. The developing device as set forth in claim 1, wherein:
the supply toner diffusion screw rotates in a direction in which the developer present in a bottom part of the supply toner carrying path (i) is scooped up and (ii) is then carried upward from bottom along a surface of the partition board which surface faces the supply toner carrying path.

4. A developing device as set forth in claim 1, further comprising:
a drainboard having one side located near a surface of the developing roller and another side, opposite to the one side, which is located in the supply toner carrying path, the drainboard inclining downward from the one side to the another side,
the drainboard guiding the developer borne by the developing roller to the supply toner carrying path.

5. The developing device as set forth in claim 1, wherein:
a developer stirring member is provided between the supply toner diffusion screw and the developing roller in the developing tank, and the supply toner diffusion screw has a shaft center which is higher than a shaft center of the developer stirring member.

6. The developing device as set forth in claim 1, wherein:
the second region of the partition board has a height that (i) is lower than that of the shaft center of a rotation shaft of the supply toner diffusion screw and (ii) equals to or is greater than a height of a lowest point that a periphery of the supply toner diffusion screw reaches.

7. The developing device as set forth in claim 6, wherein:
the first region of the partition board equals in height to the shaft center of the rotation shaft of the supply toner diffusion screw.

8. An image forming apparatus, comprising:
a photoreceptor;
a charging device for charging a surface of the photoreceptor;
an exposure device for forming an electrostatic latent image by exposing the surface of the photoreceptor charged by the charging device;
a developing device for forming a toner image by developing the electrostatic latent image formed on the surface of the photoreceptor;
a toner supply device for supplying toner to the developing device;
a transfer device for transferring the toner image formed on the surface of the photoreceptor onto a recording medium; and
a fixing device for fixing the toner image, transferred onto the recording medium, to the recording medium,
the developing device, including:
a developing tank, which contains developer containing toner and magnetic carrier and which has a toner supply opening through which toner is supplied into the developing tank;
a developing roller, provided in the developing tank, that bears the developer to supply the developer to a photoreceptor;
a supply toner carrying path, provided in the developing tank, that (i) is separated from a region on a developing roller side by a partition board provided parallel to the developing roller, (ii) is provided longer than an opening length of the toner supply opening in a longitudinal direction of the toner supply opening, and (iii) receives the toner supplied through the toner supply opening; and
a supply toner diffusion screw, provided in the supply toner carrying path, that (i) rotates to stir and diffuse supplied toner in the supply toner carrying path and (ii) moves, beyond the partition board, the supplied toner in the supply toner carrying path so as to supply the supplied toner to the region on the developing roller side,
the partition board having, in an axial direction of the supply toner diffusion screw, a first region and a second region lower than the first region, the first region being located so as to face a region perpendicularly below the toner supply opening in the supply toner carrying path, and the second region being located so as not to face the region perpendicularly below the toner supply opening in the supply toner carrying path.
